(19) United States
(12) Patent Application Publication
(10) Pub. No.: US 2011/0224109 A1
(43) Pub. Date: Sep. 15, 2011

(54) Reversible Peptide Surfactants For Oilfield Applications

(76) Inventors: Syed A. Ali, Sugar land, TX (US); Iain Cooper, Sugar Land, TX (US)

(21) Appl. No.: 13/062,043

(22) PCT Filed: Sep. 4, 2009
(86) PCT No.: PCT/IB2009/053874

§ 371 Date: May 5, 2011

Related U.S. Application Data
(60) Provisional application No. 61/094,286, filed on Sep. 4, 2008.

(51) Int. Cl. C09K 8/38; C09K 8/536; C09K 8/70

(52) U.S. Cl. 507/131; 507/244

(57) ABSTRACT

The invention discloses a foam composition comprising a self-assembled, force-transmitting peptide network prepared by: a) dissolving or dispersing a peptide surfactant in a liquid to form a solution; and b) mixing the solution with a gas (e.g., nitrogen, carbon dioxide) to form a foam.

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

The statements made herein merely provide background information related to the present disclosure and may not constitute prior art, or describe some embodiments illustrating the invention.

Surfactants adsorb at air/water and oil/water interfaces and stabilize emulsions and foams. The stability of emulsion or foam is dependent on the stability of surfactant at fluid-fluid interface. Currently, collapsing foams or coalescing emulsions requires the use of de-foamers and de-emulsifiers. It is desirable to have surfactants that enable the creation of stable emulsions and foams that can also be reversibly switched to allow the complete coalescence of the emulsion or collapse of the foam. A family of peptide surfactants capable of stabilizing foams and emulsions in a stimuli-responsive manner, based on the reversible formation of a mechanically strong interfacial film are identified and discovered by the inventors to function in unique and novel ways for oilfield application. These peptide surfactants employ reversible switching of a collection of weak bonds. Unlike cleavable surfactants, the peptide surfactants are not covalently altered by switching process, which can be repeated multiple times and is complete within seconds. Switching is achieved by a change in the bulk solution composition, such as a change in pH or the addition of metal ions, for example. Considerably smaller than proteins, peptide surfactants adsorb rapidly at interfaces and possess properties superior to those of traditional emulsifying and foaming agents. Embodiments according to the invention relate to the potential applications of peptide surfactant in the oilfield, some of which are described in further detail herein below. However, in addition to other operations described elsewhere within this disclosure, some fluid embodiments are useful in oilfield operations, including, but not limited to, such operations as fracturing subterranean formations, modifying the permeability of subterranean formations, fracture or wellbore cleanup, acid fracturing, drilling, matrix acidizing, gravel packing or sand control, and the like. Another application includes the placement of a chemical plug to isolate zones or to assist an isolating operation.

Surfactant-Enhanced Waterfloods. In surfactant-enhanced waterfloods, a surfactant is often constantly mixed with injection or produced water and injected into reservoir. When the mixture returns to the surface, it carries emulsified oil. The emulsion can be difficult to break; the breaking process expensive, energy intensive, and very inefficient. Furthermore, the residual oil concentrations in the returned fluid are often too high and must be diluted before disposal or re-injection. Alternatively, peptide surfactants offer advantage over traditional surfactants. Recovered from oil-water-surfactant emulsions, the reversible peptide surfactant could reduce the cost and environmental impact from a growing number of tertiary recovery projects. Depending on sweep efficiencies, peptide surfactant could help release much, such as 50-70% of, oil from micropores. The oil may be held in place in micropores by surface tension and capillary pressures.

Foam Diversion in Matrix Acidizing. The proper placement of acid can be one factor in matrix acidizing. Often, much of the acid flows into the undamaged zone, leaving the damage zone untreated. Foam has been used to divert the acid to the damaged area. However, the complexity of foam behavior in porous media has reduced the efficiency of diversion. It has been suggested that the key to acid diversion is trapping of as much of the gas in the foam as possible. Peptide surfactants may serve to stabilize gas bubbles; and thus stabilize the foam.

Foam-assisted Sand Clean-out with Tubulars (i.e. Coiled Tubing). Currently, the primary candidates for foam clean-out are vertical wells with low BHPs and large diameter completions. However, the complexity and handling of returned foam at the surface often eliminates it as a sand clean-out option. The use of reversible peptide surfactant offers an attractive option for sand clean-out.

Pickling of Tubing in Low BHP Wells. The purpose of the tubing pickle treatment is to clean the production tubing from any damaging material (mill scale, rust, debris) prior to conducting the main stimulation treatment. If not removed, these materials can enter the formation and can cause damage. The pickle treatments are performed either via coiled tubing or bullheading. In the bullheading method, the acid and/or solvent are pumped down the production tubing; then the spent acid is lifted to the surface using reservoir pressure. In the case of coiled tubing, the acid is pumped down the coil and spent acid lifted, using reservoir pressure, through the coil tubing/production tubing annulus. In both methods, reservoir pressure is utilized for the flowback of the spent acid to the surface. In low bottom-hole pressure wells, the foaming of the pickle treatment is necessary to lift the spent acid to the surface. The foaming of the pickle fluids with peptide surfactant can provide stable foam that can be easily broken at the surface.

Emulsified Acids. Emulsified acids (e.g., up to 20 wt % HCl) have been successfully used to stimulate (acid fracturing) various types of wells in carbonate formations. To prepare an emulsified acid, a suitable emulsifier is needed. The emulsifier should form a stable emulsion at the surface and at the bottomhole temperature. The peptide surfactants offer an advantage over other conventional emulsifiers because of their ability to form stable emulsions. Since peptide surfactants are reversible, the emulsified spent acid is easily broken at the surface. Furthermore, the use peptide surfactant can minimize the surfactant loss due to adsorption onto the carbonate rock, enhancing the deep penetration of acid into the formation.

Foam Fracturing. Nitrogen foam fracturing is a method to stimulate low-pressure, shallow gas reservoirs. Foams in the range of 60 to 80 qualities are typically used in foam fracturing, so the proppant is easily transported by the foam and then supported once the fracture has been created. As a result, the proppant is more uniformly distributed within the fracture rather than simply allowed to settle to the bottom. Foam has been shown to have excellent fluid loss properties for the low permeability formations. The major advantage of a foam fracturing fluid is its fluid recovery efficiency. The clean-up of a foam fracturing treatment is usually accomplished within days; whereas a gelled water fracturing treatment may require a week or longer. Since peptide surfactants are known to produce very stable foam, they are well suited for use in foam fracturing.

Foamed Acid Fracture Acidizing. The use of foamed acid in fracture acidizing of carbonate formations can give the same benefits as foam in hydraulic fracturing treatment. Foam quality and foam stability affect the acid etched fracture flow capacity. The peptide surfactants are well suited for producing good quality and stable foams.

Foamed Drilling Fluids. For underbalanced drilling operations, where there may be additional concerns relating to formation damage, foamed drilling fluids are used. The foam quality is usually predicted via modeling of expected downhole conditions. The foam quality is an important parameter in that it defines the downhole fluid rheology. Being able to control the foam rheology downhole can have important consequences for the cuttings carrying capability of the drilling fluid, as well as the hydraulic efficiency through the drillbit. The peptide surfactants can give more precise control of the quality downhole, and hence improved fluid rheological properties. The downhole rheology (yield stress and viscosity) may be controlled “on the fly” by pH trigger, which may enable more efficient drilling by matching the fluid rheology to the rate of penetration, so that increased cuttings loading at faster ROPs can be handled.

Foamed Cements. Formations that have a low fracturing gradient, are highly permeable, vuggy or cavernous pose difficulties to cementing operations. Ultra-low density cement systems can provide a solution to such problems. Foamed cements are coarse dispersions of a base cement slurry, a gas (usually nitrogen), a foaming surfactant, and other materials to provide foam stability. The low density of foamed cements reduces losses, and can also be used to control shallow water flows in deepwater wells.

The foam stability can be affected by the foaming agent, the quantity of gas, the chemical and physical composition of the slurry, thermodynamic factors and the mixing method and conditions. Unstable foams develop lower compressive strength, higher permeability and inferior bonding properties. As with drilling fluids, being able to more accurately control the foam cement properties downhole can lead to a more robust wellbore cement, and potentially tunable parameters in terms of mechanical properties, foam rheology, and even potentially the thermal and electrical properties of the cement, which can lead to improved behind-casing log interpretation.

Additionally, surfactants, under the right circumstances, entrain invading gas downhole to create stable foams. This foam can present significant resistance to flow of gas bubbles, limiting their upward migration through the cement column Thus, controlling the stability of the foam with a reversible peptide surfactant, could enable differing degrees of gas migration to be handled in the same cement slurry.

As used herein, the term “liquid phase” or “liquid” is meant to include all components of a fluid except the gas phase. The term “gas” is used herein to describe any fluid in a gaseous state or in a supercritical state, wherein the gaseous state refers to any state for which the temperature of the fluid is below its critical temperature and the pressure of the fluid is below its vapor pressure, and the supercritical state refers to any state for which the temperature of the fluid is above its critical temperature. As used herein, the terms “energized fluid” and “fluid” are used interchangeably, in the proper context, to describe any stable mixture of gas phase and liquid phase, including foams, notwithstanding the foam quality value, i.e. the ratio of gas volume to the total volume of gas and liquid phases.

Energized fluids are often used in the stimulation of oil and gas wells, and are formed and applied by injecting an aqueous solution concomitantly with a gas (most commonly nitrogen, carbon dioxide or their mixtures). The dispersion of the gas into the base fluid in the form of bubbles increases the viscosity of such fluid and impacts positively its performance, temperatures. As such, aqueous energized fluids can include an aqueous medium, a gas component, an optional viscosifier, an optional electrolyte, and a surfactant. The aqueous medium is usually water or brine. The fluids may also include an organoamino compound. When used as fracturing fluids, embodiments may further include a proppant.

In some embodiments, fluid embodiments include a suitable chelant, such as DAE, HEIDA, EDTA and HEDTA, for any purpose, such as scale/precipitant control. Such fluids may be acidic fluids that are useful in stimulation and workover operations, and in particular, for the control of iron in acidizing operations, the removal of alkaline earth carbonate scale in scale removal operations, and matrix or fracture acidizing operations. The fluids, such as those described in U.S. Pat. No. 6,436,880 can include an optional acid, such as hydrochloric acid; water; and a hydroxyethylaminocarboxylic acid. Some examples of hydroxyethylaminocarboxylic acids are hydroxyethylethylenediaminetriacetic acid (HEDTA) and hydroxyethyliminodiacetic acid (HEIDA), or any salts thereof.

In some embodiments, any proppant (or gravel) can be used, provided that it is compatible with the base and bridging-promoting materials if the latter are used, the formation, the fluid, and the desired results of the treatment. Such proppants can be natural or synthetic, coated, or contain chemicals; more than one can be used sequentially or in mixtures of different sizes or different materials. Proppants and gravels in the same or different wells or treatments can be the same material and/or the same size as one another and the term “proppant” is intended to include gravel in this discussion. In general the proppant used will have an average particle size of from about 0.15 mm to about 2.5 mm, more particularly, but not limited to typical size ranges of about 0.25-0.43 mm, 0.43-0.85 mm, 0.85-1.18 mm, 1.18-1.70 mm, and 1.70-2.36 mm. Normally the proppant will be present in the slurry in a concentration of from about 0.12 kg proppant added to each L of carrier fluid to about 3 kg proppant added to each L of carrier fluid, preferably from about 0.12 kg proppant added to each L of carrier fluid to about 1.5 kg proppant added to each L of carrier fluid.

Embodiments of the invention may also include placing proppant particles that are substantially insoluble in the fluids of the formation. Proppant particles carried by the treatment fluid remain in the fracture created, thus propping open the fracture when the fracturing pressure is released and the well is put into production. [Any proppant (gravel) can be used, provided that it is compatible with the base and the bridging-promoting materials if the latter are used, the formation, the fluid, and the desired results of the treatment. Such proppants (gravels) can be natural or synthetic, coated, or contain chemicals; more than one can be used sequentially or in mixtures of different sizes or different materials. Proppants and gravels in the same or different wells or treatments can be the same material and/or the same size as one another and the term “proppant” is intended to include gravel in this discussion. Proppant is selected based on the rock strength, injection pressures, types of injection fluids, or even completion design. Some proppant materials include, but are not limited to, sand, sintered bauxite, glass beads, ceramic materials, naturally occurring materials, or similar materials. Mixtures of proppants can be used as well. Naturally occurring materials may be underived and/or unprocessed naturally occurring materials, as well as materials based on naturally occurring materials that have been processed and/or derived. Suitable examples of naturally occurring particulate materials for use as proppants include, but are not necessarily limited to: ground or crushed shells of nuts such as walnut, coconut, pecan, almond, ivory nut, brazil nut, etc.; ground or crushed seed shells (including fruit pits) of seeds of fruits such as plum, olive, peach, cherry, apricot, etc.; ground or crushed seed shells of other plants such as maize (e.g., corn cobs or corn kernels), etc.; processed wood materials such as those derived from woods such as oak, hickory, walnut, poplar, mahogany, etc., including such woods that have been processed by grinding, chipping, or other form of particalization, processing, etc, some nonlimiting examples of which are proppants supplied under the tradename LitePropTM available from BJ Services Co., made of walnut hulls impregnated and encapsulated with resins. Further information on some of the above-noted compositions thereof may be found in Encyclopedia of Chemical Technology, Edited by Raymond E. Kirk and Donald F. Othmer, Third Edition, John Wiley & Sons, Volume 16, pages 248-273 (entitled “Nuts”), Copyright 1981.

Fluids may also include a viscosifier that may be a polymer that is either crosslinked or linear, a viscoelastic surfactant, or any combination thereof. Some nonlimiting examples of suitable polymers include guar gums, high-molecular weight polysaccharides composed of mannose and galactose sugars, or guar derivatives such as hydroxypropyl guar (HPG), carboxymethyl guar (CMG), and carboxymethylhydroxypropyl guar (CMHPG). Cellulose derivatives such as hydroxyethylcellulose (HEC) or hydroxypropylcellulose (HPC) and carboxymethylhydroxyethylcellulose (CMHEC) may also be used. Any useful polymer may be used in either crosslinked form, or without crosslinker in linear form. Xanthan, diutan, and scleroglucan, three biopolymers, have been shown to be useful as viscosifying agents. Synthetic polymers such as, but not limited to, polyacrylamide and polyacrylate polymers and copolymers are used typically for high-temperature applications. Nonlimiting examples of suitable viscoelastic surfactants useful for viscosifying some fluids include cationic surfactants, anionic surfactants, zwitterionic surfactants, amphoteric surfactants, nonionic surfactants, and combinations thereof. Also, associative polymers for which viscosity properties are enhanced by suitable surfactants and hydrophobically modified polymers can be used, such as cases where a a charged polymer in the presence of a surfactant having a charge that is opposite to that of the charged polymer, the surfactant being capable of forming an ion-pair association with the polymer resulting in a hydrophobically modified polymer having a plurality of hydrophobic groups, as described in published application U.S. 20040209780A1, Harris et. al.

When incorporated in fluids, polymer based viscosifier may be present at any suitable concentration. In various embodiments hereof, the gelling agent can be present in an amount of from about 10 to less than about 60 pounds per thousand gallons of liquid phase, or from about 15 to less than about 40 pounds per thousand gallons, from about 15 to about 35 pounds per thousand gallons, 15 to about 25 pounds per thousand gallons, or even from about 17 to about 22 pounds per thousand gallons. Generally, the gelling agent can be present in an amount of from about 10 to less than about 50 pounds per thousand gallons of liquid phase, with a lower limit of polymer being no less than about 10, 11, 12, 13, 14, 15, 16, 17, 18, or 19 pounds per thousand gallons of the liquid phase, and the upper limited being less than about 50 pounds per thousand gallons, no greater than 59, 54, 49, 44, 39, 34, 30, 29, 28, 27, 26, 25, 24, 23, 22, 21, or 20 pounds per thousand gallons of the liquid phase. In some embodiments, the polymers can be present in an amount of about 20 pounds per thousand gallons. Hydroxypropyl guar, carboxymethyl hydroxypropyl guar, carboxymethyl guar, cationic functional guar, guar or mixtures thereof, are some polymers for use. Fluids incorporating polymer based viscosifiers based viscosifiers may have any suitable viscosity, preferably a viscosity value of about 50 mPa-s or greater at a shear rate of about 100 s⁻¹ at treatment temperature, more preferably about 75 mPa-s or greater at a shear rate of about 100 s⁻¹, and even more preferably about 100 mPa-s or greater.

When a VES is incorporated into fluids, the VES can range from about 0.2% to about 15% by weight of total weight of liquid phase, preferably from about 0.5% to about 15% by weight of total weight, more preferably from about 2% to about 10% by weight of total weight. The lower limit of VES should be no less than about 0.2, 0.5, 0.7, 0.9, 1, 2, 3, 4, 5, 6, 7, 8, 9, 10, or 14 percent of total weight, and the upper limited being no more than about 15 percent of total fluid weight, specifically no greater than about 15, 14, 13, 12, 11, 10, 9, 8, 7, 6, 5, 1, 0.9, 0.7, 0.5 or 0.3 percent of total weight. Fluids incorporating VES based viscosifiers may have any suitable viscosity, preferably a viscosity value of less than about 100 mPa-s at a shear rate of about 100 s⁻¹ at treatment temperature, more preferably less than about 75 mPa-s at a shear rate of about 100 s⁻¹, and even more preferably less than about 50 mPa-s.

When incorporated, a gas component of the fluids may be produced from any suitable gas that forms an energized fluid/foam when introduced into the liquid phase medium. See, for example, U.S. Pat. No. 3,937,283 (Blauer et al.). The gas component may comprise a gas selected from the group consisting of nitrogen, air, carbon dioxide and any mixtures thereof. The fluid may contain from about 10% to about 90% volume gas component based upon total fluid volume percent, preferably from about 30% to about 80% volume gas component based upon total fluid volume percent, and more preferably from about 40% to about 70% volume gas component based upon total fluid volume percent.

Friction reducers may also be incorporated into some embodiments. Any friction reducer may be used. Also, polymers such as polyacrylamide, polyisobutyl methacrylate, polymethyl methacrylate and polyisobutylene as well as water-soluble friction reducers such as guar gum, guar gum derivatives, polyacrylamide, and polyethylene oxide may be used. Commercial drag reducing chemicals such as those sold by Conoco Inc. under the trademark “CDR” as described in U.S. Pat. No. 3,692,676 (Culter et al.) or drag reducers such as those sold by Chemlink designated under the trademarks “FLO 1003, 1004, 1005 & 1008” have also been found to be effective. These polymeric species added as friction reducers or viscosity index improvers may also act as excellent fluid loss additives reducing or even eliminating the need for conventional fluid loss additives.

Fluids may also include a breaker. The purpose of this component is to “break” or diminish the viscosity of the fluid so that this fluid is more easily recovered from the formation during cleanup. With regard to breaking down viscosity, oxidizers, enzymes, or acids may be used. Breakers reduce the polymer's molecular weight by the action of an acid, an oxidizer, an enzyme, or some combination of these on the polymer itself. In the case of borate-crosslinked gels, increasing the pH and therefore increasing the effective concentration of the active crosslinker, the borate anion, reversibly create the borate crosslinks. Lowering the pH can just as easily eliminate the borate/polymer bonds. At a high pH above 8, the borate ion exists and is available to crosslink and cause gelling. At lower pH, the borate is tied up by hydrogen and is not available for crosslinking, thus gelation caused by borate ion is reversible.

Aqueous mediums may be water or brine. In those embodiments where the aqueous medium is a brine, the brine is water comprising an inorganic salt and/or organic salt. Some inorganic salts include alkali metal halides, more preferably potassium chloride. The carrier brine phase may also comprise an organic salt more preferably sodium or potassium formate. Some inorganic divalent salts include calcium halides, more preferably calcium chloride or calcium bromide. Sodium bromide, potassium bromide, or cesium bromide may also be used. The salt is chosen for compatibility reasons i.e. where the reservoir drilling fluid used a particular brine phase and the completion/clean up fluid brine phase is chosen to have the same brine phase.

A fiber component may be included in some fluids to achieve a variety of properties including improving particle suspension, and particle transport capabilities, and gas phase stability. Fibers used may be hydrophilic or hydrophobic in nature. Fibers can be any fibrous material, such as, but not necessarily limited to, natural organic fibers, comminuted plant materials, synthetic polymer fibers (by non-limiting example polyester, polyaramide, polyamide, novoloid or a novoloid-type polymer), fibrillated synthetic organic fibers, ceramic fibers, inorganic fibers, metal fibers, metal filaments, carbon fibers, glass fibers, ceramic fibers, natural polymer fibers, and any mixtures thereof. Particularly useful fibers are polyester fibers coated to be highly hydrophilic, such as, but not limited to, DACRON® polyethylene terephthalate (PET) Fibers available from Invista Corp. Wichita, Kans., USA, 67220. Other examples of useful fibers include, but are not limited to, polylactic acid polyester fibers, polyglycolic acid polyester fibers, polyvinyl alcohol fibers, and the like. When used the fiber component may be include at any suitable concentration, such as but not limited to from about 1 to about 15 grams per liter of the liquid phase of the fluid, from about 2 to about 12 grams per liter of liquid, or from about 2 to about 10 grams per liter of liquid

Fluid embodiments may further contain other additives and chemicals that are known to be commonly used in oilfield applications by those skilled in the art. These include, but are not necessarily limited to, materials such as surfactants in addition to those mentioned hereinabove, breaker aids in addition to those mentioned hereinabove, oxygen scavengers, alcohols, scale inhibitors, corrosion inhibitors, fluid-loss additives, bactericides, and the like. Also, they may include co-surfactants, oxidizers such as ammonium persulfate and sodium bromate, and biocides such as 2,2-dibromo-3-nitrilopropionamine.

Another embodiment includes the use of fluids for hydraulically fracturing a subterranean formation. Techniques for hydraulically fracturing a subterranean formation will be known to persons of ordinary skill in the art, and will involve pumping the fracturing fluid into the borehole and out into the surrounding formation. The fluid pressure is above the minimum in situ rock stress, thus creating or extending fractures in the formation. See Stimulation Engineering Handbook, John W. Ely, Pennwell Publishing Co., Tulsa, Okla. (1994), U.S. Pat. No. 5,551,516 (Normal et al.), “Oilfield Applications”, Encyclopedia of Polymer Science and Engineering, vol. 10, pp. 328-366 (John Wiley & Sons, Inc. New York, N.Y., 1987) and references cited therein.

In most cases, a hydraulic fracturing consists of pumping a proppant-free viscous fluid, or pad, usually water with some fluid additives to generate high viscosity, into a well faster than the fluid can escape into the formation so that the pressure rises and the rock breaks, creating artificial fractures and/or enlarging existing fractures. Then, proppant particles are added to the fluid to form a slurry that is pumped into the fracture to prevent it from closing when the pumping pressure is released.

In the fracturing treatment, fluids may be used in the pad treatment, the proppant stage, or both. The components of the liquid phase can be mixed on the surface. Alternatively, a the fluid may be prepared on the surface and pumped down tubing while the gas component could be pumped down the annular to mix down hole, or vice versa.

Yet another embodiment includes the use fluids for cleanup. The term “cleanup” or “fracture cleanup” refers to the process of removing the fracture fluid (without the proppant) from the fracture and wellbore after the fracturing process has been completed. Techniques for promoting fracture cleanup traditionally involve reducing the viscosity of the fracture fluid as much as practical so that it will more readily flow back toward the wellbore. While breakers are typically used in cleanup as energized fluids, the fluids of the invention are inherently effective for use in cleanup operations, with or without a breaker.

Another embodiment relates to use of fluids for gravel packing a wellbore. As a gravel packing fluid, it comprises gravel or sand and other optional additives such as filter cake clean up reagents such as chelating agents referred to above or acids (e.g. hydrochloric, hydrofluoric, formic, acetic, citric acid) corrosion inhibitors, scale inhibitors, biocides, leak-off control agents, among others. For this application, suitable gravel or sand is typically having a mesh size between 8 and 70 U.S. Standard Sieve Series mesh.

1. A foam composition comprising a self-assembled, force-transmitting peptide network prepared by: a) dissolving or dispersing a peptide surfactant in a liquid to form a solution; and b) mixing the solution with a gas to form a foam.

2. The composition of claim 1, wherein the foam fluid is used to divert acid into damaged zone and away from the undamaged zone during matrix acid acidizing of sandstones or carbonates.

3. The composition of claim 1, wherein the foam fluid is used via coiled tubing to clean-out sand deposits from the wellbore.

4. The composition of claim 1 comprising a peptide surfactant prepared by: a) dissolving or dispersing a peptide surfactant in HCl acid (10-22%) solution; and b) mixing the acid solution with nitrogen gas to form a foamed acid.

5. The composition of claim 4, wherein the foamed acid is pumped into the production tubing to remove mill scale, rust and other deposits from the tubing walls.

6. The composition of claim 5, wherein the foamed acid containing tubing deposits is returned to the surface, and subsequently, foamed acid is de-foamed with appropriate chemicals.

7. The composition of claim 1, wherein the foamed acid solution is pumped at high rates into the carbonate formation to create an etched fracture.

8. The composition of claim 1, wherein the foam fluid is pumped at high rates to stimulate low-pressure, shallow gas reservoirs (sandstones and shales).

9. The composition of claim 1 as used in a method wherein the peptide surfactant is constantly mixed with either produced water or injection water into an injection zone, and returned emulsified oil is separated with appropriate chemicals.

10. The composition of claim 1, wherein the foam fluid is used to control the downhole rheological parameters of a drilling fluid, to control the cuttings carrying capability and hydraulic horsepower through a drillbit.

11. The composition of claim 1, wherein the foam fluid is used to tune the mechanical, rheological, thermal and electrical properties of cement.

12. The composition of claim 1, wherein the foam fluid is used to entrain varying degrees of invading gas downhole, and thus avoid subsequent problems with the stability of the cemented wellbore.

13. The composition of claim 1 further comprising a chelant.

14. The composition of claim 1 wherein the fluid comprises nitrogen, carbon dioxide, or any mixture thereof.

15. The composition of claim 1 wherein the fluid comprises carbon dioxide, and the carbon dioxide effectively lowers the pH of the fluid during and/or subsequent a treatment operation.

16. A foam composition comprising a self-assembled, force-transmitting peptide network prepared by: a) dissolving or dispersing a peptide surfactant in a liquid to form a solution; and b) mixing the solution with a gas to form a foam, wherein the peptide surfactant is prepared by: a) dissolving or dispersing a peptide surfactant in HCl acid (10-22%) solution; and b) mixing the acid solution with nitrogen gas to form a foamed acid.

17. The composition of claim 16, wherein the foamed acid is pumped into the production tubing to remove mill scale, rust and other deposits from the tubing walls.

18. The composition of claim 17, wherein the foamed acid containing tubing deposits is returned to the surface, and subsequently, foamed acid is de-foamed with appropriate chemicals.

19. A foam composition comprising a chelant, a self-assembled, force-transmitting peptide network prepared by: a) dissolving or dispersing a peptide surfactant in a liquid to form a solution; and b) mixing the solution with a gas to form a foam.

20. The composition of claim 19 wherein the fluid comprises carbon dioxide, and the carbon dioxide effectively lowers the pH of the fluid during and/or subsequent a treatment operation.
